(19) United States
(12) Patent Application Publication
(10) Pub. No.: US 2014/0029640 A1
(43) Pub. Date: Jan. 30, 2014

(54) SOLID-STATE LASER DEVICE

(71) Applicants: Tetsuo Kojima, Chiyoda-ku (JP); Hiroyuki Suzuki, Chiyoda-ku (JP); Tatsuhide Takayama, Chiyoda-ku (JP); Yoshio Saitou, Chiyoda-ku (JP)

(72) Inventors: Tetsuo Kojima, Chiyoda-ku (JP); Hiroyuki Suzuki, Chiyoda-ku (JP); Tatsuhide Takayama, Chiyoda-ku (JP); Yoshio Saitou, Chiyoda-ku (JP)

(73) Assignee: Mitsubishi Electric Corporation, Chiyoda-ku ,Tokyo (JP)

(21) Appl. No.: 14/110,378

(22) PCT Filed: Apr. 8, 2011
(86) PCT No.: PCT/JP2011/002092

§ 371 Date: Oct. 7, 2013

(51) Int. Cl. H01S 3/094

(52) U.S. Cl. CPC H01S 3/094
USPC 372/75

(57) ABSTRACT

In a conventional solid-state laser device, uniformity of an excitation distribution around the axis of a solid-state laser medium is only considered, and symmetry of the excitation distribution in the optical axis direction of the solid-state laser device as a whole is not considered. Therefore, there has been a problem that it is difficult to generate a high-power and high-quality laser beam with high efficiency. In order to solve the problem, in the present invention, excitation modules 51, 52 of an even number is provided, along the optical axis of a solid-state laser beam 18, near the center of a resonator, and semiconductor lasers 21-28 serving as excitation light sources and solid-state laser media 11, 12 provided in the excitation module 51 or in the excitation module 52 are arranged to be symmetrical with respect to a virtual symmetry plane 61 located at a center gap between the excitation modules of the even number.

### TECHNICAL FIELD

The present invention relates to a solid-state laser device having a configuration in which a solid-state laser medium is excited by a plurality of excitation light sources.

### BACKGROUND ART

In a conventional solid-state laser device, a configuration is employed in which a plurality of excitation modules are provided in the solid-state laser device and the excitation modules are arranged in series optically. Opening portions are provided for the respective excitation modules. For example, when there are two excitation units, opening portions are arranged in opposite directions each other, and when there are three or more excitation units, the respective directions of the opening portions are arranged to equally divide the circumference around the optical axis. Two excitation light sources are provided for each of the opening portions. In this way, excitation intensity is strengthened concentrating on an excitation area around the optical axis, so that the effect of thermal strain generated in the excitation modules is removed in total (for example, see Patent Document 1).

### PRIOR ART DOCUMENTS

### Patent Documents

Patent Document 1: Japanese Unexamined Patent Application Publication No. H5-335662 (Paragraphs [0024] through [0026], FIG. 6)

### SUMMARY OF THE INVENTION

### Problem That the Invention is to Solve

In a conventional solid-state laser device, uniformity of an excitation distribution with respect to the axis of a solid-state laser medium is only considered, and symmetry of the excitation distribution in the optical axis direction of the solid-state laser device as a whole is not considered. Therefore, there has been a problem that it is difficult to generate a high-power and high-quality laser beam with high efficiency.

### Means for Solving the Problem

Excitation modules of an even number are provided near the center of a resonator along the optical axis of a laser beam, and excitation light sources and solid-state laser media provided in each of the excitation modules are arranged to be symmetrical with respect to a virtual symmetry plane located at a center gap between the excitation modules of the even number.

### Advantageous Effects of the Invention

Excitation distributions and thermal lenses that a solid-state laser beam experiences when it passes through excitation portions of the solid-state laser media can be made substantially symmetrical with respect to the virtual symmetry plane. As a result, quality of high-power laser beam can be improved by suppressing generation of the following situation: if solid-state laser beam is influenced by thermal-strain asymmetry of the solid-state laser media when the beam passes through the media, symmetry of beam transmission is lost especially when a high-power laser beam is outputted, and thus, the solid-state laser beam is deformed and beam quality is deteriorated.

### BRIEF DESCRIPTION OF DRAWINGS

FIG. 1 is a perspective view showing a solid-state laser device according to Embodiment 1 of the present invention.

FIG. 2 is a top view showing the solid-state laser device according to Embodiment 1 of the present invention.

FIG. 3 shows principal parts of the solid-state laser device according to Embodiment 1 of the present invention, and (a) through (h) in FIG. 3 show A-A, B-B, C-C, D-D, E-E, F-F, G-G, and H-H sectional views in FIG. 2, respectively.

FIG. 4 is a diagram for explaining laser beam transmission status in the solid-state laser device according to Embodiment 1 of the present invention.

FIG. 5 shows diagrams of excitation intensity distributions in solid-state laser media in Working Example 1 of the present invention, and (a) through (h) in FIG. 5 show excitation intensity distributions at cross sections shown in (a) through (h) in FIG. 3, respectively, when viewed from the total reflection mirror 13 side.

FIG. 6 is a diagram showing an excitation intensity distribution in the solid-state laser medium in Working Example 1 of the present invention, and shows the excitation intensity distribution, when viewed from the total reflection mirror 13 side, obtained by superimposing the excitation intensity distributions at the cross sections shown in (a) through (d) in FIG. 5.

FIG. 7 is a perspective view showing a solid-state laser device according to Embodiment 2 of the present invention.

FIG. 8 is a perspective view showing a solid-state laser device according to Embodiment 3 of the present invention.

FIG. 9 is a top view showing the solid-state laser device according to Embodiment 3 of the present invention.

FIG. 10 shows diagrams of excitation intensity distributions, synthesized by image transcription, in solid-state laser media in Embodiment 3 of the present invention, and (a) through (d) in FIG. 10 show excitation intensity distributions, when viewed from the total reflection mirror 13 side, obtained by synthesizing cross-section excitation intensity distributions of excitation light sources 21 and 25, 22 and 26, 23 and 27, and 24 and 28 in FIG. 9, respectively.

FIG. 11 is a top view showing a solid-state laser device according to Embodiment 4 of the present invention.

FIG. 12 is a top view showing a solid-state laser device according to Embodiment 5 of the present invention.

FIG. 13 shows principal parts of the solid-state laser device according to Embodiment 5 of the present invention, and (a) through (h) in FIG. 13 show A-A, B-B, C-C, D-D, E-E, F-F, G-G, and H-H sectional views in FIG. 12, respectively.

FIG. 14 is a detailed diagram of a semiconductor laser base in the solid-state laser device according to Embodiment 5 of the present invention.

FIG. 15 is a perspective view showing a solid-state laser device according to Embodiment 6 of the present invention.

### MODE FOR CARRYING OUT THE INVENTION

### Embodiment 1

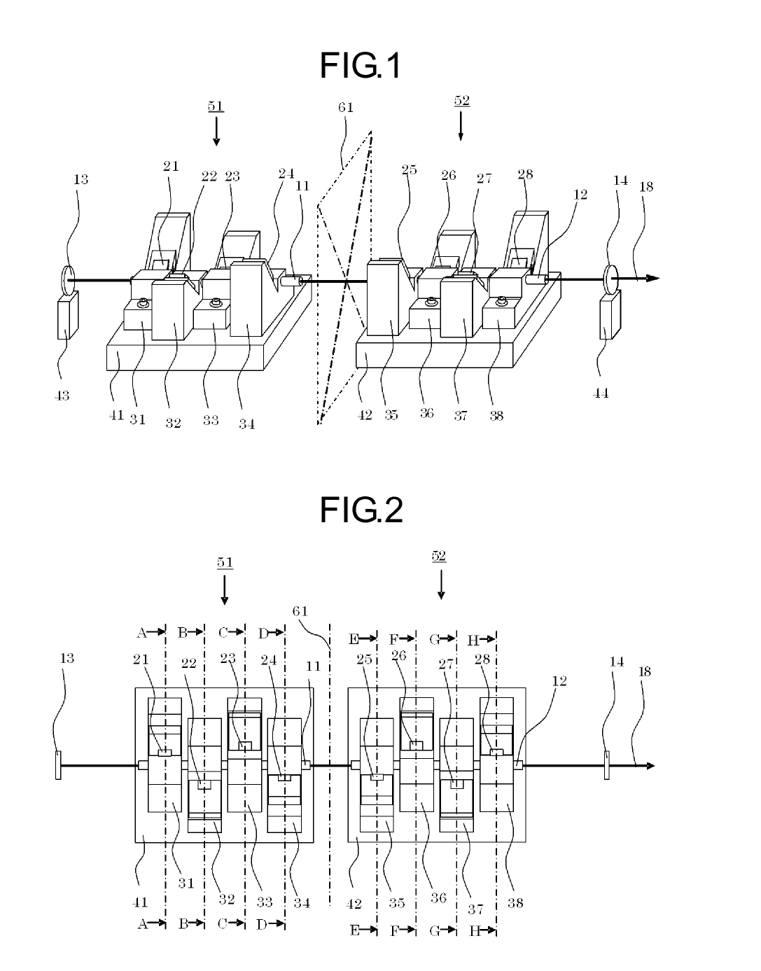

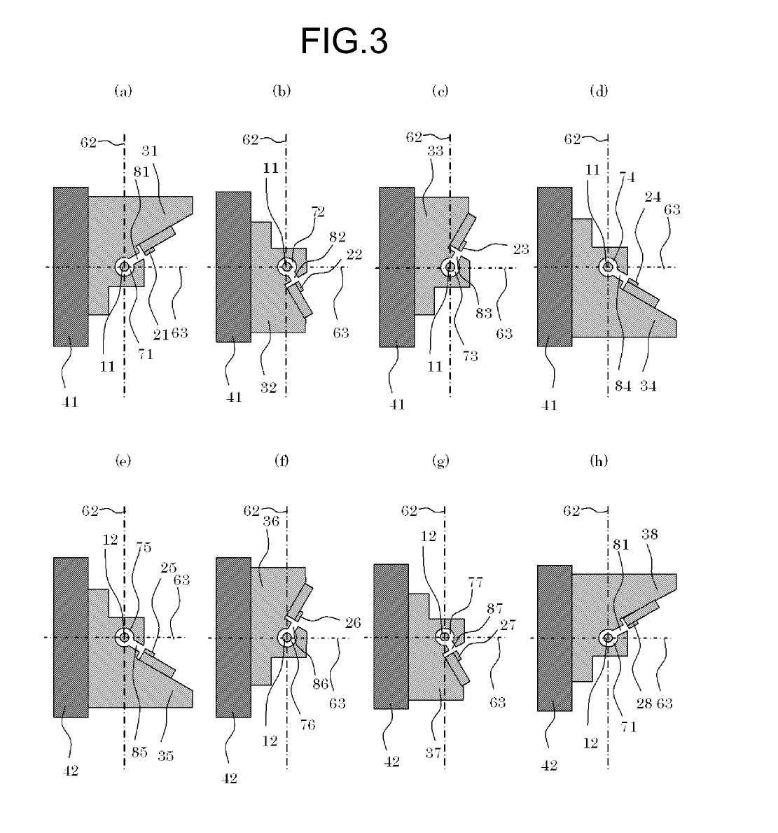

FIGS. 1 through 3 show a solid-state laser device according to Embodiment 1 of the present invention. FIG. 1 is a perspective view, FIG. 2 is a top view, and (a) through (h) in FIG. 3 show A-A, B-B, C-C, D-D, E-E, F-F, G-G, and H-H sectional views in FIG. 2, respectively.

As shown in FIG. 1, the solid-state laser device includes a total reflection mirror 13 and a partial reflection mirror 14 that configure a resonator, and two excitation modules 51, 52 are arranged in series between the mirrors. Here, the excitation module arranged at the total reflection mirror 13 side is called as the first excitation module 51 and the excitation module arranged at the partial reflection mirror 14 side is called as the second excitation module 52.

The first excitation module 51 includes a first solid-state laser medium 11 of a rod type, and a plurality of semiconductor lasers 21-24, serving as excitation light sources for exciting the first solid-state laser medium from its lateral side, which are arranged along the optical axis of a laser beam 18 and each of which are configured with a semiconductor laser bar including a light emission unit and a heat sink. The four semiconductor lasers are provided, which are called as the first semiconductor laser 21, the second semiconductor laser 22, the third semiconductor laser 23, and the fourth semiconductor laser 24 from the total reflection mirror 13 side. In addition, there are provided four semiconductor laser bases 31-34 for supporting respectively the first through fourth semiconductor lasers 21-24 along with the first solid-state laser medium 11, and a first base 41 for supporting the semiconductor laser bases 31-34. The four semiconductor laser bases are called as the first semiconductor laser base 31, the second semiconductor laser base 32, the third semiconductor laser base 33, and the fourth semiconductor laser base 34, each of which corresponds to each of the four semiconductor lasers.

Similarly, the second excitation module 52 includes a second solid-state laser medium 12 of a rod type, fifth through eighth semiconductor lasers 25-28 serving as excitation light sources, fifth through eighth semiconductor laser bases 35-38 for supporting respectively the fifth through eighth semiconductor lasers 25-28 along with the second solid-state laser medium 12, and a second base 42 for supporting the semiconductor laser bases 35-38. The fifth semiconductor laser 25 through the eighth semiconductor laser 28 and the fifth semiconductor laser base through the eighth semiconductor laser base are arranged from the total reflection mirror 13 side.

Note that, as the excitation module in Embodiment 1 is set for each of the solid-state laser media, there exist two excitation modules since there are two solid-state laser media in FIG. 1. Even if the first base 41 and the second base 42 are formed monolithically as one member in FIG. 1, i.e. if two solid-state laser media are provided on one base, there exist two excitation modules.

The total reflection mirror 13 and the partial reflection mirror 14 are fixed to a first holder 43 and a second holder 44, respectively.

The first and second solid-state laser media 11, 12 contains an active medium thereinside; are members each having a function for amplifying a beam by forming an inverted population triggered by an excitation light emission; are made of Nd:YAG

(Neodymium/Yttrium Aluminum Garnet), for example; and have a rod-type shape, preferably a cylindrical shape. Note that the first and second solid-state laser media 11, 12 are in the same shape (length, figure, etc.).

The first through eighth semiconductor lasers 21-28 each have a function to generate an excitation light for exciting the first solid-state laser media 11 or the second solid-state laser media 12, and a side excitation configuration is employed in the present invention, in which the excitation light is projected from a lateral side of the first and second solid-state laser media 11, 12.

The first through eighth semiconductor lasers 21-28, via the heat sinks thereof, are respectively fixed onto the first through eighth semiconductor laser bases 31-38. Between the first through eighth semiconductor lasers 21-28 and the first through eighth semiconductor laser bases 31-38, respectively, soft metals such as indium, resin sheets or ceramics having high heat conductivity, or the like are provided (not shown), so that the heat transfer can be improved between the heat sinks of the first through eighth semiconductor lasers and the first through eighth semiconductor laser bases 31-38, respectively.

The first through eighth semiconductor laser bases 31-38 are made of metal materials having high heat radiation performance such as copper. As shown in (a) through (h) in FIG. 3, respectively formed monolithically are pedestals for arranging the first through eighth semiconductor lasers 21-28 with predetermined height and angle, first through eighth cylindrical holes 71-78 for storing the first and second solid-state laser media 11, 12, and light focusing surfaces having partial-cylinder shape for reflecting the excitation light from the semiconductor lasers 21-28 and trapping the excitation light in the cylindrical holes 71-78.

As shown in (a) through (h) in FIG. 3, in the first through eighth semiconductor laser bases 31-38, first through eighth slits 81-88, each of which corresponds to each of the semiconductor lasers 21-28, are formed at portions facing the excitation light emitting surfaces of the first through eighth semiconductor lasers 21-28 so that the excitation light from the first through eighth semiconductor lasers 21-28 can pass through. High reflectivity films such as gold plate are formed at least on the light focusing surfaces having the cylindrical shape in the first through eighth semiconductor laser bases 31-38 and on the wall surfaces of the first through eighth slits 81-88, so that the excitation light from the first through eighth semiconductor lasers 21-28 can be reflected efficiently.

The first and second solid-state laser media 11, 12 are fixed in the cylindrical holes 71-78 respectively formed in the first through eighth semiconductor laser bases 31-38 with potting agents or adhesives, etc. (not shown) which are substantially transparent against the excitation light from the first through eighth semiconductor lasers 21-28. The potting agents or the adhesives, etc. have a function of, other than supporting the first and second solid-state laser media 11, 12, transferring heat generated in the first and second solid-state laser media 11, 12 to the first through eighth semiconductor laser bases 31-38.

The first through eighth semiconductor laser bases 31-38 are provided onto the first base 41 or the second base 42. Between the first through eighth semiconductor laser bases 31-38 and the first base 41 or the second base 42, soft metals such as indium, resin sheets or ceramics having high heat conductivity, or the like are provided (not shown), so that the heat transfer can be promoted between the first through eighth semiconductor laser bases 31-38 and the first base 41 or the second base 42.

The first and second bases 41, 42 are made of metal materials having high heat radiation performance such as copper, and are cooled by the water flowing therethrough or the thermoelectric cooling device (Peltier device) provided thereunder, so as to have a function of cooling heat generating members, i.e. the first through eighth semiconductor lasers 21-28 and the first and second solid-state laser media 11, 12, via the first through eighth semiconductor laser bases 31-38.

In this solid-state laser device, the solid-state laser beam 18 generated in the first and second excitation modules 51, 52 is amplified every time it passes through the first and second excitation modules 51, 52 while traveling back and forth in the resonator comprised with the total reflection mirror 13 and the partial reflection mirror 14. A part of the solid-state laser beam 18 traveling back and forth in the resonator transmits the partial reflection mirror 14 and is taken out to the outside of the solid-state laser device.

In the solid-state laser device in Embodiment 1, the first through fourth semiconductor lasers 21-24 and the fifth through eighth semiconductor lasers 25-28, which are provided in the first excitation module 51 and the second excitation module 52, respectively, are arranged to be symmetrical with respect to a virtual symmetry plane 61, which is perpendicular to the axis of the laser beam 18, located at the gap between the first excitation module 51 and the second excitation module 52. Since the first solid-state laser medium 11 and the second solid-state laser medium 12 have the same shape, the first solid-state laser medium 11 and the second solid-state laser medium 12 are configured to be symmetrical with respect to the virtual symmetry plane 61.

Mirrors having the same curvature are employed in the total reflection mirror 13 and the partial reflection mirror 14. The first excitation module 51 and the second excitation module 52 are arranged so that the virtual symmetry plane 61, which is located at the gap between the first excitation module 51 and the second excitation module 52, will be located at the optical center of the resonator comprised with the total reflection mirror 13 and the partial reflection mirror 14. In other words, the total reflection mirror 13, the partial reflection mirror 14, and the excitation modules 51, 52 configure a symmetrical resonator.

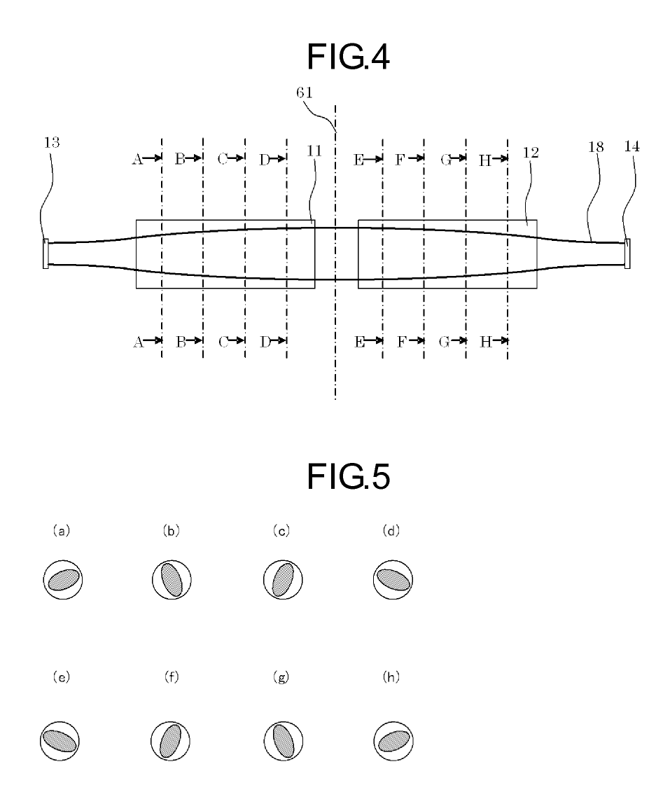

FIG. 4 is a cross-sectional view along a first plane 62 that contains the central axes of the solid-state laser media 11, 12 in FIG. 3 and that is parallel to the surfaces of the bases 41, 42. Note that FIG. 4 is depicted by extracting, from the solid-state laser device, only the solid-state laser media 11, 12, the total reflection mirror 13, the partial reflection mirror 14, and the solid-state laser beam 18, and that the solid-state laser beam 18 is depicted with consideration of the beam diameter in the direction perpendicular to its axis. In addition, while the first plane 62 is set to be parallel to the bases 41, 42, such a setting is made for descriptive purposes and this is not a limitation. Any plane may be employed so long as it contains the central axes of the solid-state laser media 11, 12, i.e. the optical axis of the laser beam 18.

As shown in FIG. 4, when the excitation modules 11, 12 are arranged at around the center of the symmetrical resonator, the beam diameter of the solid-state laser beam 18 changes so as to be symmetrical with respect to the virtual symmetry plane 61 which also serves as the resonator center. Therefore, the beam diameter of the solid-state laser beam 18 at each of A-A, B-B, C-C, and D-D cross-section positions in FIG. 2 is the same with that at each of H-H, G-G, F-F, and E-E cross-section positions in FIG. 2, respectively. As a result, the solid-state laser beam 18 is affected by the thermal lens and thermal strain, having the same intensity distribution, of the solid-state laser media at the respective A-A and H-H, B-B and G-G, C-C and F-F, and D-D and E-E cross-section positions in FIG. 2 each pair of which has the same excitation distribution and the same beam diameter.

As described above, in Embodiment 1, the excitation modules 51, 52 are arranged at around the center of the symmetrical resonator, and the excitation light sources 21-28, which are provided in the excitation modules 51, 52, are arranged to be symmetrical with respect to the virtual symmetry plane 61 located at the gap between the excitation modules 51, 52. Thus, since the excitation distributions and the thermal lenses that the solid-state laser beam 18 experiences when it passes through excitation portions of the solid-state laser media 11, 12 are symmetrical with respect to the virtual symmetry plane 61, it is possible to make the solid-state laser beam 18 to be ideally transmitted in the symmetrical resonator, i.e. to be transmitted symmetrical with respect to the virtual symmetry plane 61. As a result, quality of high-power laser beam can be improved by avoiding the following situation: if solid-state laser beam is influenced by thermal-strain asymmetry of the solid-state laser media when the beam passes through the media, symmetry of beam transmission is lost especially when a high-power laser beam is outputted, and thus, the solid-state laser beam is deformed and beam quality is deteriorated.

Because the excitation modules 51, 52 are arranged at around the center of the symmetrical resonator, the shape of the solid-state laser beam 18 which travels in the resonator, whose beam diameter becomes largest at the resonator center and becomes smallest both at the total reflection mirror 13 and the partial reflection mirror 14, can be centrosymmetric with respect to the optical axis direction, thereby making it possible to improve the utilization efficiency of the solid-state laser media 11, 12. As a result, it is possible to generate a high-power and high-quality laser beam with higher efficiency.

As shown in FIGS. 1 and 3, in Embodiment 1, as for the incident directions of the excitation light from the semiconductor lasers 21-28 in the excitation modules 51, 52, i.e. the incident angles with respect to the first plane 62 that contains the central axes of the solid-state laser media 11, 12, a configuration is employed so as to have two or more different directions. Thus, because the solid-state laser media 11, 12 can be excited uniformly, it is possible to further improve the beam quality of the high-power laser beam.

As shown in FIG. 3, because the semiconductor lasers 21-28 are provided on one side with respect to the first plane 62 that contains the central axes of the solid-state laser media 11, 12, if the first plane 62 is substantially parallel to the surfaces of the bases 41, 42, operations of attaching the semiconductor laser bases onto the bases and attaching the excitation light sources onto the semiconductor laser bases can be accessed from one side. Therefore, a solid-state laser device that is possible to generate a high-power and high-quality laser beam with high efficiency can be configured simply, and its assembling can be simplified.

As shown in FIG. 3, since one semiconductor laser is allocated at each spot of the solid-state laser media 11, 12 in their longitudinal direction, heat density of the solid-state laser media in their longitudinal direction can be decreased. Therefore, a solid-state laser device that is possible to generate a high-power and high-quality laser beam with high efficiency can be obtained with a simple cooling configuration.

Note that, as shown in FIGS. 1 through 3, while a case is described in Embodiment 1 in which the symmetrical resonator is configured with two excitation modules, the resonator may be configured with more than two excitation modules. However, the number of excitation modules should be an even number, because a plurality of excitation modules are arranged to be symmetrical with respect to the virtual symmetry plane 61 located at the center gap between the plurality of excitation modules. That is, there may be a case in which one excitation module is provided on one side with respect to the virtual symmetry plane 61 and there are two excitation modules in total, a case of two on one side and four in total, or a case of three on one side and six in total, etc. Naturally, it is necessary to provide excitation light sources of excitation modules to be symmetrical with respect to the virtual symmetry plane 61. The same applies to other embodiments.

In addition, while a case is described in Embodiment 1 in which one excitation module is configured with four semiconductor lasers, an excitation module may be configured with two, three, or no less than five semiconductor lasers. Naturally, it is necessary to provide semiconductor lasers to be symmetrical with respect to the virtual symmetry plane 61. The same applies to other embodiments.

Also, the above-described configurations such as employing two or more different incident directions of the excitation light, providing excitation light sources on one side with respect to the first plane 62, and allocating one excitation light source at each spot, are employed so that the effect, obtained by configuring the excitation light sources to be symmetrical with respect to the virtual symmetry plane 61, will be further improved. Therefore, the above-described configurations are not mandatory in Embodiment 1, but just preferable ones. The same can be applied to other embodiments.

Furthermore, while the description on the symmetrical resonator is made in Embodiment 1, this is not a limitation and an oscillator other than the symmetrical type may be employed. In other words, it is mandatory to provide the excitation modules to be symmetrical with respect to the virtual symmetry plane 61 located at the center gap between the plurality of excitation modules which are arranged along the optical axis of the laser beam, but, for example, the curvature of the total reflection mirror 13 may differ from that of the partial reflection mirror 14, or the distance between the total reflection mirror 13 and one excitation module may differ from that between the partial reflection mirror 14 and another excitation module. In these cases, because the beam diameters at symmetrical positions with respect to the virtual symmetry plane 61 are not the same, the effect of getting the same thermal lens and thermal strain at symmetrical positions is a bit decreased. The same can be applied to other embodiments.

Still further, while the semiconductor lasers 21-28, the semiconductor laser bases 31-38, and the bases 41, 42 are configured by separate members in Embodiment 1, semiconductor laser bases and a base may be formed monolithically as one member for each excitation module, or semiconductor laser bases and bases for all excitation modules may be formed monolithically. In these cases, it is possible to generate, with high efficiency, a high-power and high-quality laser beam with a space-saving configuration. The same can be applied to other embodiments.

Next, specific Working Example 1 according to Embodiment 1 will be described.

### Working Example 1

The excitation modules 51, 52 are provided in the resonator, and the semiconductor lasers 21-24 and the semiconductor lasers 25-28 are arranged in the two excitation modules, respectively.

A concrete disposition of the semiconductor lasers 21-28 will be described with reference to FIG. 3. The incident angle, with respect to the first plane 62 which is parallel to the surfaces of the bases 41, 42, of the excitation light from the first semiconductor laser 21 arranged in the first excitation module 51 is 67.5 degrees from the upper right direction, as shown in (a) in FIG. 3. Likewise, a configuration is employed such that the incident angle of the second semiconductor laser 22 excitation light with respect to the first plane 62 is 22.5 degrees from the lower right direction as shown in (b) in FIG. 3; the incident angle of the third semiconductor laser 23 excitation light with respect to the first plane 62 is 22.5 degrees from the upper right direction as shown in (c) in FIG. 3; and the incident angle of the fourth semiconductor laser 24 excitation light with respect to the first plane 62 is 67.5 degrees from the lower right direction as shown in (d) in FIG. 3. The incident angle, with respect to the first plane 62, of the excitation light from the fifth semiconductor laser 25 arranged in the second excitation module 52 is 67.5 degrees from the lower right direction, as shown in (e) in FIG. 3. Likewise, a configuration is employed such that the incident angle of the sixth semiconductor laser 26 excitation light with respect to the first plane 62 is 22.5 degrees from the upper right direction as shown in (f) in FIG. 3; the incident angle of the seventh semiconductor laser 27 excitation light with respect to the first plane 62 is 22.5 degrees from the lower right direction as shown in (g) in FIG. 3; and the incident angle of the eighth semiconductor laser 28 excitation light with respect to the first plane 62 is 67.5 degrees from the upper right direction as shown in (h) in FIG. 3.

By employing this configuration, all the angles are set to be 90 degrees, i.e. the incident angle of the excitation light from the second semiconductor laser 22 with respect to the excitation light from the first semiconductor laser 21, the incident angle of the excitation light from the fourth semiconductor laser 24 with respect to the excitation light from the third semiconductor laser 23, the incident angle of the excitation light from the sixth semiconductor laser 26 with respect to the excitation light from the fifth semiconductor laser 25, and the incident angle of the excitation light from the eighth semiconductor laser 28 with respect to the excitation light from the seventh semiconductor laser 27.

As shown in FIG. 3, each pair of the first semiconductor laser 21 and the eighth semiconductor laser 28; the second semiconductor laser 22 and the seventh semiconductor laser 27; the third semiconductor laser 23 and the sixth semiconductor laser 26; and the fourth semiconductor laser 24 and the fifth semiconductor laser 25, is arranged to generate the excitation light in the same direction. As shown in FIG. 2, the first through fourth semiconductor lasers 21-24 and the fifth through eighth semiconductor lasers 25-28 are arranged to be symmetrical with respect to the virtual symmetry plane 61 located at the gap between the first excitation module 51 and the second excitation module 52.

FIG. 5 shows excitation distributions at cross sections of the first and second solid-state laser media 11, 12, and outer circles denote the external form of the solid-state laser media and hatched portions denote strongly-excited portions in the cross sections. In FIG. 5, (a) through (h) in FIG. 5 show excitation distributions at cross sections A-A, B-B, C-C, D-D, E-E, F-F, G-G, and H-H in FIG. 2, respectively.

In FIG. 2, when the solid-state laser beam 18 travels through the resonator in the left-hand direction from the virtual symmetry plane 61 and passes through the first solid-state laser medium 11, the beam experiences the thermal lenses caused by the excitation distributions shown in (d), (c), (b), and (a) in FIG. 5 in this order. Meanwhile, when the solid-state laser beam 18 travels through the resonator in the right-hand direction from the virtual symmetry plane 61 and passes through the second solid-state laser medium 12, the beam experiences the thermal lenses caused by the excitation distributions shown in (e), (f), (g), and (h) in FIG. 5 in this order. As shown in FIG. 4, because the beam diameter of the solid-state laser beam 18 at each of A-A, B-B, C-C, and D-D cross-section positions in FIG. 2 is the same with that at each of H-H, G-G, F-F, and E-E cross-section positions in FIG. 2, respectively, the beam diameter of the solid-state laser beam 18 when it experiences the thermal lens shown in each of (a), (b), (c), and (d) in FIG. 5 is the same with the beam diameter when it experiences the thermal lens shown in each of (h), (g), (f), and (e) in FIG. 5, respectively. Thus, since the directivity of excitation intensity and thermal lens that the solid-state laser beam 18 experiences when it travels through the resonator are also symmetrical with respect to the virtual symmetry plane 61, it is possible to generate a high-power and high-quality laser beam with high efficiency.

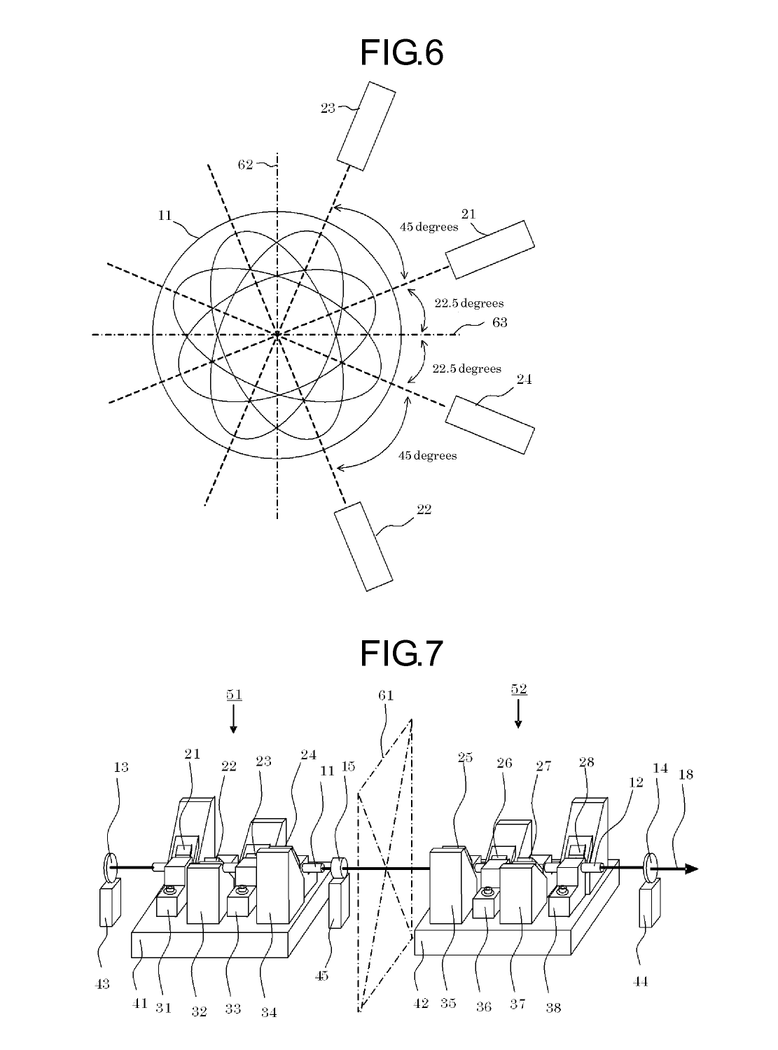

In Working Example 1, when one solid-state laser medium is excited by four semiconductor lasers, since the respective semiconductor lasers are arranged to have an angular deviation of 45 degrees with each other when viewed from the axial direction of the solid-state laser medium as shown in FIG. 3, the solid-state laser medium can be excited to be centrosymmetric with respect to the axis. In other words, when (a) through (d) in FIG. 5 are superimposed, four excitation distributions generated by the excitation light from the semiconductor lasers 21-24 are in axially symmetrical distributions as shown in FIG. 6. When the number is other than four, for example, when excited by three semiconductor lasers, they may be arranged to have a 60-degree angular deviation when viewed from the axial direction of the solid-state laser medium, and when excited by five, may be arranged a 36-degree angular deviation. If the above is extended to a generalization, when n semiconductor lasers are provided, the semiconductor lasers may be arranged to have an angular deviation of 180/n degrees with each other when viewed from the axial direction of the solid-state laser medium.

In Working Example 1, as shown in FIG. 3, the semiconductor lasers are arranged to be symmetrical, when viewed from the optical axis direction of the laser beam 18, with respect to a second plane 63 that is perpendicular to the first plane 62 and that contains the optical axis of the laser beam 18. That is, as shown in FIG. 6, four semiconductor lasers are arranged at positions having ±22.5 degrees (for example, the first semiconductor laser 21 and the fourth semiconductor laser 24) and positions having ±67.5 degrees (for example, the second semiconductor laser 22 and the third semiconductor laser 23) with respect to the plane 63 so that four semiconductor lasers will be arranged to have an angular deviation of 45 degrees with each other when viewed from the optical axis direction of the laser beam 18 and to be symmetrical with respect to the plane 63. As it is obvious from FIG. 3, by employing the above-described arrangement, the first semiconductor laser base 31 and the fourth semiconductor laser base 34 can be configured by simply arranging the same member in a reversed manner, and the second semiconductor laser base 32 and the third semiconductor laser base 33 can be configured by simply arranging the other same member in a reversed manner. The same can be applied to the fifth through eighth semiconductor laser bases 35-38. Therefore, while eight semiconductor lasers are used in Working Example 1, only two types of semiconductor laser bases are necessary, thereby making it possible to decrease the types of components drastically.

### Embodiment 2

FIG. 7 is a perspective view showing a solid-state laser device according to

Embodiment 2 of the present invention. In FIG. 7, reference numerals same with those in FIG. 1 indicate the same or corresponding portions. In the solid-state laser device in Embodiment 2, a 90-degree polarizing rotator 15 that rotates the polarizing direction of the laser beam 18 by 90 degrees around the optical axis is further provided onto the solid-state laser device shown in Embodiment 1.

The 90-degree polarizing rotator 15 is fixed to a holder 45, arranged between the first excitation module 51 and the second excitation module 52, and configured so that the polarizing directions of the solid-state laser beam 18 will differ between the first excitation module 51 and the second excitation module 52 by 90 degrees.

As described above, since the 90-degree polarizing rotator 15 is arranged between two excitation modules and the polarizing directions of the solid-state laser beam 18 differ between two excitation modules by 90 degrees, the thermal lenses, which differ depending on the polarizing directions, of the solid-state laser media can be equalized throughout the resonator. As a result, a higher-quality laser beam with high power can be generated with high efficiency.

As described in Embodiment 1, note that a configuration including more than two excitation modules is possible as long as the number thereof is even. In this case, by locating the 90-degree polarizing rotator at a center gap between a plurality of arranged excitation modules, the polarizing directions of the solid-state laser beam 18 differ by 90 degrees between the excitation modules provided at the partial reflection mirror side and the excitation modules provided at the total reflection mirror side when viewed from the 90-degree polarizing rotator. Thus, the thermal lenses, which differ depending on the polarizing directions, of the solid-state laser media can be equalized throughout the resonator.

### Embodiment 3

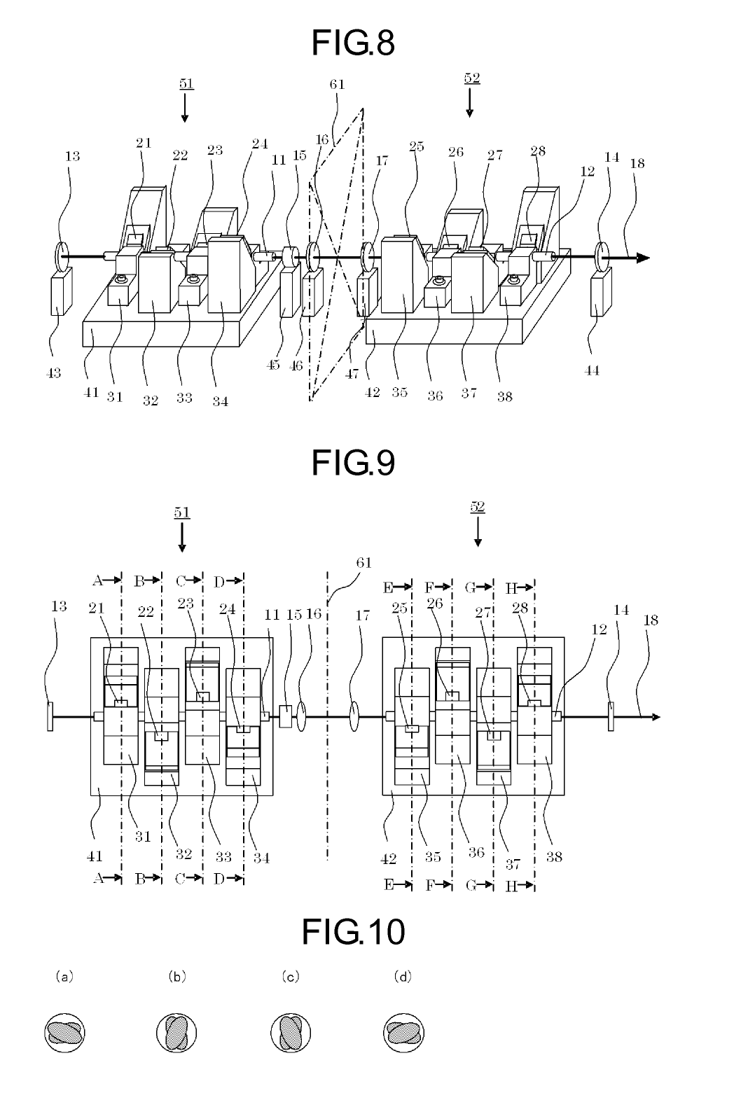

FIGS. 8 and 9 show a solid-state laser device according to Embodiment 3 of the present invention; where FIG. 8 is a perspective view and FIG. 9 is a top view. In FIGS. 8 and 9, reference numerals same with those in FIG. 7 indicate the same or corresponding portions. In the solid-state laser device in Embodiment 3, two lenses 16, 17 are further provided onto the solid-state laser device shown in Embodiment 2, between the first excitation module 51 and the second excitation module 52 and along the laser beam 18. The first lens 16 on the total reflection mirror 13 side is fixed to a first holder 46 and the second lens 17 on the partial reflection mirror 14 side is fixed to a second holder 47.

As for an arrangement of two lenses, two types of configuration could be considered depending on thermal lens intensity of the solid-state laser media. When the thermal lens effect is small, the focal length and the arrangement of the lenses 16, 17 are selected to have an optical system in which the center point of the first solid-state laser medium 11 is image-transcribed onto the center point of the second solid-state laser medium 12.

As described above, by arranging, between the excitation modules 51, 52, the optical system in which the center point of the first solid-state laser medium 11 is image-transcribed onto the center point of the second solid-state laser medium 12, the excitation distributions of one solid-state laser medium can be image-transcribed onto the other solid-state laser medium when the thermal lens effects of the solid-state laser media 11, 12 are small, thereby being able to make the excitation distributions at the respective cross sections in the solid-state laser media to be more equalized. As a result, when the excitation intensity is small, i.e. when low-powered, it is possible to generate a higher-quality laser beam with higher efficiency.

Meanwhile, as for a thermal lens which exceeds thermal lens intensity operable as a stable resonator in the above described configuration, an arrangement is employed in which only the distance between two lenses is shortened in the image transcription optical system configured with the lenses having the above-described focal length and arrangement. That is, while the distance between the first solid-state laser medium 11 and the first lens 16, and the distance between the second solid-state laser medium 12 and second lens 17 are the same with those in the image transcription optical system, the distance between the first lens 16 and the second lens 17 is shorter than that in the image transcription optical system.

As described above, by arranging, between the plurality of excitation modules, the optical system in which the distance between the lenses in the image transcription optical system is shortened, when the excitation intensity is large, i.e. when the thermal lens effects of the solid-state laser media are stronger, the excitation distributions of one solid-state laser medium can be image-transcribed onto the other solid-state laser medium, thereby being able to make the excitation distributions at the respective cross sections in the solid-state laser media to be more equalized. As a result, when the excitation intensity is large, i.e. when high-powered, it is possible to generate a higher-quality laser beam with higher efficiency.

As described in Embodiment 1, note that a configuration including more than two excitation modules is possible as long as the number thereof is even. In this case, by locating the lenses 16, 17 at a center gap between a plurality of arranged excitation modules, the excitation distributions of the solid-state laser medium provided at the partial reflection mirror side and the excitation distributions of the solid-state laser medium provided at the total reflection mirror side, when viewed from the lenses 16, 17, can be image-transcribed onto the solid-state laser medium provide at the opposite side. Thus, it is possible to make the excitation distributions to be more equalized.

Next, specific Working Example 2 according to Embodiment 3 will be described.

### Working Example 2

A configuration of a solid-state laser device in Working Example 2 is shown in FIGS. 8 and 9. The excitation modules 51, 52 are the same or corresponding ones in Working Example 1, and a specific arrangement of the semiconductor lasers 21-28 are the same with that shown in FIG. 3 of Working Example 1.

As for the arrangement of the lenses 16, 17, while the distance between the first solid-state laser medium 11 and the first lens 16, and the distance between the second solid-state laser medium 12 and second lens 17 are the same with those in the image transcription optical system, the distance between the first lens 16 and the second lens 17 is shorter than that in the image transcription optical system.

In this solid-state laser device, excitation distributions at cross sections of the solid-state laser media are the same with those shown in FIG. 5 of Working Example 1, and excitation distributions at A-A cross section through H-H cross section in FIG. 9 are shown in (a) in FIG. 5 through (h) in FIG. 5, respectively.

By an optical system comprised with the lenses 16, 17, when high power is inputted, E-E cross section in FIG. 2 is substantially image-transcribed onto A-A cross-section position; F-F cross section substantially onto B-B cross-section position; G-G cross section substantially onto C-C cross-section position; and H-H cross section substantially onto D-D cross-section position.

Because excitation distributions are also image-transcribed by image transcription, it can be considered that an excitation distribution at a position subjected to the image transcription is obtained by synthesizing an original excitation distribution at that position and an image-transcribed excitation distribution of its source position. FIG. 10 shows excitation distributions in which image-transcribed excitation distributions at cross sections of the solid-state laser media are synthesized, and (a) through (d) in FIG. 10 show excitation distributions obtained by synthesizing excitation distributions at E-E and A-A, F-F and B-B, G-G and C-C, and H-H and D-D cross sections, respectively.

As shown in FIG. 10, because the respective areas of strongly excited portions in the excitation distributions synthesized by image transcription are broader than those in the excitation distributions of cross sections shown in FIG. 5, i.e. excitation distributions are more nearly uniform, it is found that the excitation distributions of the respective cross sections in the solid-state laser media can be made more uniform. As a result, it is possible to generate a higher-quality and high-power laser beam with higher efficiency.

In Embodiment 3, while the solid-state laser device is shown as an example, in which the 90-degree polarizing rotator 15 and the lenses 16, 17 are provided between the plurality of excitation modules, a solid-state laser device in which only the lenses 16, 17 are provided between the plurality of excitation modules may be possible, which has the effect same with that of the solid-state laser device in Embodiment 3.

### Embodiment 4

FIG. 11 is a top view showing a solid-state laser device according to Embodiment 4 of the present invention. In FIG. 11, reference numerals same with those in FIG. 9 indicate the same or corresponding portions. In the solid-state laser device in Embodiment 4, a third excitation module 151 for exciting a third solid-state laser medium 111 and a fourth excitation module 152 for exciting a fourth solid-state laser medium 112, both of which are located along the optical axis of the laser beam 18, are further provided onto the configuration shown in FIG. 9, between the total reflection mirror 13 and the first excitation module 51, and between the partial reflection mirror 14 and the second excitation module 52, respectively.

The third excitation module 151 includes the third solid-state laser medium 111;

ninth through twelfth semiconductor lasers 121-124 serving as excitation light sources; ninth through twelfth semiconductor laser bases 131-134 for supporting the ninth through twelfth semiconductor lasers 121-124 and the third solid-state laser medium 111; and a third base 141 for supporting ninth through twelfth semiconductor laser bases 131-134. The ninth through twelfth semiconductor lasers 121-124 are arranged in directions that are the same with or corresponding to those of lasers in the first excitation module 51. The third excitation module is provided, adjacent to the first excitation module 51, between the first excitation module 51 and the total reflection mirror 13.

Similarly, the fourth excitation module 152 includes the fourth solid-state laser medium 112; thirteenth through sixteenth semiconductor lasers 125-128 serving as excitation light sources; thirteenth through sixteenth semiconductor laser bases 135-138 for supporting the thirteenth through sixteenth semiconductor lasers 125-128 and the fourth solid-state laser medium 112; and a base 142 for supporting thirteenth through sixteenth semiconductor laser bases 135-138. The thirteenth through sixteenth semiconductor lasers 125-128 are arranged in directions that are the same with or corresponding to those of lasers in the second excitation module 52. The fourth excitation module is provided, adjacent to the second excitation module 52, between the second excitation module 52 and the partial reflection mirror 14.

The first through fourth semiconductor lasers 21-24 provided in the first excitation module 51 and the fifth through eighth semiconductor lasers 25-28 provided in the second excitation module 52 are arranged to be symmetrical with respect to the virtual symmetry plane 61 located at the gap between the first excitation module 51 and the second excitation module 52. The ninth through twelfth semiconductor lasers 121-124 provided in the third excitation module 151 and the thirteenth through sixteenth semiconductor lasers 125-128 provided in the fourth excitation module 152 are arranged to be symmetrical with respect to the virtual symmetry plane 61 located at the gap between the first excitation module 51 and the second excitation module 52.

As described above, because a plurality of excitation light sources arranged in a plurality of excitation modules are provided to be symmetrical with respect to the virtual symmetry plane 61 located at the center gap between the plurality of excitation modules, the excitation distributions and the thermal lenses that the solid-state laser beam 18 experiences when it passes through excitation portions of the solid-state laser media 11, 12, 111, and 112 are symmetrical with respect to the virtual symmetry plane 61. Thus, it is possible to make the transmission of the solid-state laser beam 18 to be symmetrical with respect to the virtual symmetry plane 61. As a result, quality of high-power laser beam can be improved by avoiding the following situation: if solid-state laser beam is influenced by thermal-strain asymmetry of the solid-state laser media when the beam passes through the media, symmetry of beam transmission is lost especially when a high-power laser beam is outputted, and thus, the solid-state laser beam is deformed and beam quality is deteriorated.

While the solid-state laser device is shown as an example in Embodiment 4, in which the third excitation module 151 is provided—adjacent to the first excitation module 51—between the first excitation module 51 and the total reflection mirror 13, and the fourth excitation module 152 is provided—adjacent to the second excitation module 52—between the second excitation module 52 and the partial reflection mirror 14, this is not a limitation. For example, the fourth excitation module 152 may be provided, adjacent to the first excitation module 51, between the first excitation module 51 and the total reflection mirror 13; and the third excitation module 151 may be provided, adjacent to the second excitation module 52, between the second excitation module 52 and the partial reflection mirror 14. In short, the same effect is obtained as long as a plurality of excitation light sources provided in a plurality of excitation modules are arranged to be symmetrical with respect to the virtual symmetry plane 61 located at the center gap between the plurality of excitation modules.

In addition, while the solid-state laser device is shown in Embodiment 4 as an example, which includes four excitation modules each of which are provided with the same number of excitation light sources, this is not a limitation. For example, the number of excitation modules, each of which are provided with the same number of excitation light sources, may be six or eight, and the number of excitation light sources to be provided to the respective excitation modules may differ from with each other. In short, an equivalent effect is obtained as long as a plurality of excitation light sources are arranged to be symmetrical with respect to the virtual symmetry plane 61 located at the center gap between the plurality of excitation modules.

In FIG. 11, a configuration is employed in which the 90-degree polarizing rotator is arranged at the center gap between the plurality of excitation modules, as described in Embodiment 2, and in which the lenses 16, 17 are arranged at the center gap between the plurality of excitation modules, as described in Embodiment 3. Thus, the effects similar to those described in Embodiments 2 and 3 can be obtained. Naturally, without these configurations, the effect achieved by arranging a plurality of excitation light sources to be symmetrical with respect to the virtual symmetry plane 61 located at the center gap between the plurality of excitation modules can be obtained.

### Embodiment 5

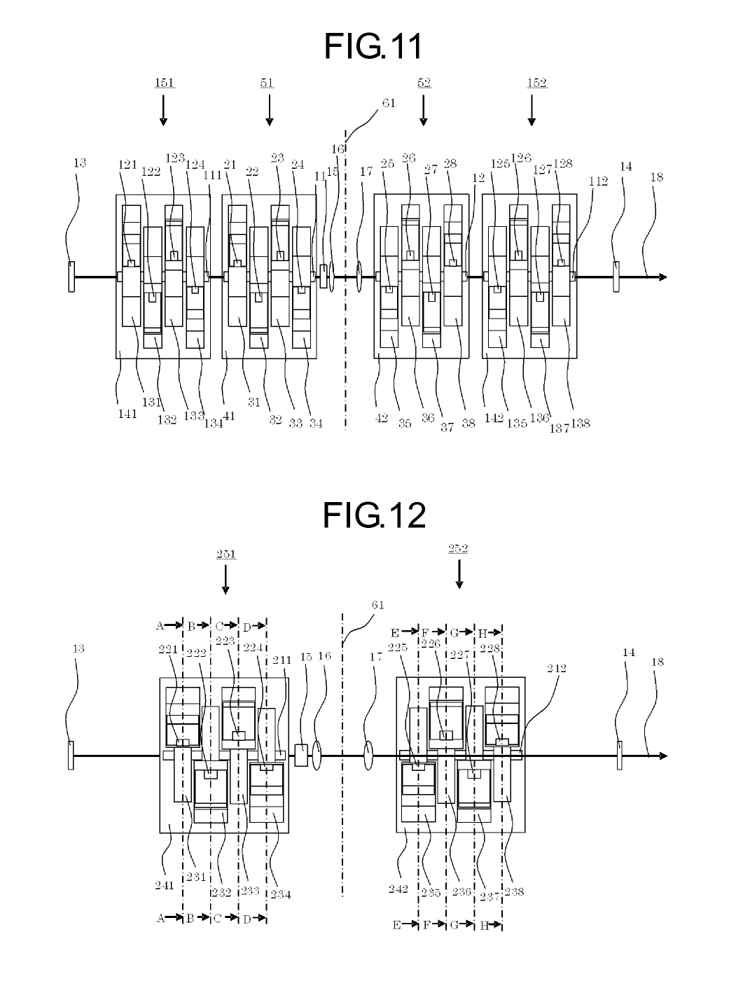

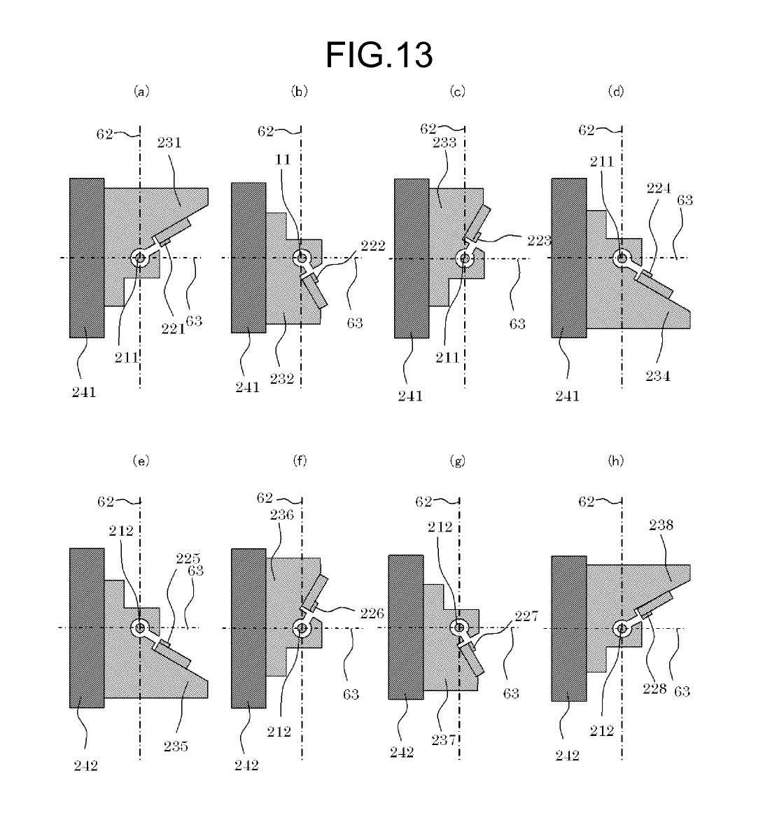

FIGS. 12 and 13 show a solid-state laser device according to Embodiment 5 of the present invention. FIG. 12 is a top view, and (a) through (h) in FIG. 13 show A-A, B-B, C-C, D-D, E-E, F-F, G-G, and H-H sectional views in FIG. 12, respectively.

As shown in FIGS. 12 and 13, the solid-state laser device in Embodiment 5 includes two excitation modules 251, 252 provided with solid-state laser media 211, 212, respectively; the total reflection mirror 13; the partial reflection mirror 14; and others. The one excitation module 251 includes the solid-state laser medium 211; four semiconductor lasers 221-224 serving as excitation light sources; four semiconductor laser bases 231-234 for supporting the semiconductor lasers 221-224 and the solid-state laser medium 211; and a base 241 for supporting the four semiconductor laser bases. Similarly, the other excitation module 252 includes the solid-state laser medium 12; four semiconductor lasers 225-228 serving as excitation light sources; four semiconductor laser bases 235-238 for supporting the semiconductor lasers 225-228 and the solid-state laser medium 212; and a base 242 for supporting the four semiconductor laser bases.

The semiconductor lasers 221-224 provided in the one excitation module 251 and the semiconductor lasers 225-228 provided in the other excitation module 252 are arranged to be symmetrical with respect to the virtual symmetry plane 61 located at the gap between the one excitation module 251 and the other excitation module 252.

In this configuration, as shown in FIG. 13, the semiconductor lasers 221-224 provided in the one excitation module 251 are arranged at the opposite side of the base 41 with respect to the first plane 62 that contains the central axis of the solid-state laser medium 211 and that is substantially parallel to the surface of the base 41. Out of the semiconductor lasers 221-224, two neighboring semiconductor lasers are arranged alternately, i.e. on the opposing sides, with respect to the second plane 63 that is perpendicular to the first plane 62 and that contains the central axes of the solid-state laser media 211, 212. The semiconductor lasers and the semiconductor laser base in the other excitation module 252 are similarly arranged so as to be symmetrical to those in the one excitation module 251 with respect to the virtual symmetry plane 61.

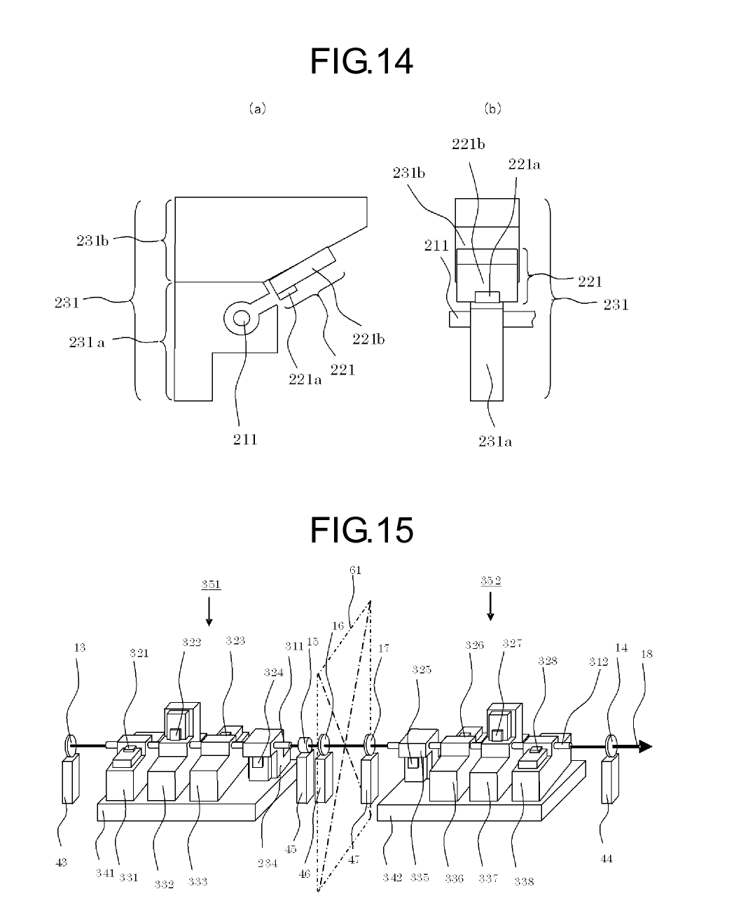

FIG. 14 is a detailed diagram of the solid-state laser medium 211, semiconductor laser 221, and semiconductor laser base 231 extracted from the excitation module 251 shown in FIG. 12, and (a) and (b) in FIG. 14 are side view and top view, respectively. The semiconductor laser 221 is configured with a semiconductor laser bar 221a including a light emission unit and a heat sink 221b, and the semiconductor laser base 231 is configured with a semiconductor laser supporting unit 231b and a solid-state laser medium supporting unit 231a. Here, the semiconductor laser supporting unit 231b and the solid-state laser medium supporting unit 231a in the semiconductor laser base 231 are formed monolithically.

The size of the semiconductor laser supporting unit 231b in the semiconductor laser base 231 is determined by the size capable of mounting the semiconductor laser 221, and the size of the solid-state laser medium supporting unit 231a in the semiconductor laser base 231 is determined as the width capable of transmitting the excitation light emitted by the semiconductor laser 221 to the solid-state laser medium 211. Therefore, the width in cross direction of the semiconductor laser supporting unit 231b in the semiconductor laser base 231 should be wider than the width of the heat sink 221b in the semiconductor laser 221, and the width in cross direction of the solid-state laser medium supporting unit 231a in the semiconductor laser base 231 should be wider than the width of the semiconductor laser bar 221a in the semiconductor laser 221. In general, the width of the semiconductor laser bar 221a is narrower than that of the heat sink 221b, and the semiconductor laser bar 221a having 10-mm width and the heat sink 221b having 25-mm width, for example, are often used. Thus, as shown in (b) in FIG. 14, the width of the solid-state laser medium supporting unit 231a in the semiconductor laser base 231 can be narrowed to around one-half compared to the width of the semiconductor laser supporting unit 231b.

In this configuration, the semiconductor lasers 221-224 and the semiconductor lasers 225-228 provided in the respective excitation modules are arranged in the axial direction of the solid-state laser media with a gap narrower than the width of the heat sinks of the semiconductor lasers 221-224 and the semiconductor lasers 225-228. In other words, the pitch of the semiconductor laser bases, i.e. the distance between A-A and B-B cross sections or between E-E and F-F cross sections in FIG. 12, for example, can be made narrower than the width of the semiconductor laser supporting unit. Here, as shown in FIG. 12, A-A cross section, etc. means a cross section along each of the central axes of the semiconductor laser bases in the top view.

As described above, because excitation light sources arranged in a plurality of excitation modules are provided to be symmetrical with respect to the virtual symmetry plane 61 located at the center gap between the plurality of excitation modules, and neighboring excitation light sources in one excitation module are more closely arranged in the optical axis direction of the laser beam 18, the solid-state laser media 11, 12 can be excited densely and the gain of the solid-state laser media 11, 12 can be increased. As a result, it is possible to further increase the efficiency of generating a high-power and higher-quality laser beam.

A configuration may be employed to Embodiment 5, in which the 90-degree polarizing rotator is arranged at the center gap between the plurality of excitation modules, as described in Embodiment 2; or the lenses 16, 17 are arranged at the center gap between the plurality of excitation modules, as described in Embodiment 3. In this case, the effect similar to that described in Embodiments 2 or 3 can be obtained.

### Embodiment 6

FIG. 15 is a perspective view showing a solid-state laser device according to Embodiment 6 of the present invention. In the solid-state laser device in Embodiment 6, the configuration of the excitation light sources in Embodiment 1 is changed so that the excitation will be made from the entire circumference direction around the axes of the solid-state laser media.

As shown in FIG. 15, the solid-state laser device in Embodiment 6 includes two excitation modules 351, 352 provided with two solid-state laser media 311, 312, respectively; the total reflection mirror 13; the partial reflection mirror 14; and others. The one excitation module 351 includes the solid-state laser medium 311; four semiconductor lasers 321-324 serving as excitation light sources; four semiconductor laser bases 331-334 for supporting the semiconductor lasers 321-324 and the solid-state laser medium 311; and a base 341 for supporting the four semiconductor laser bases. Similarly, the other excitation module 352 includes the solid-state laser medium 312; four semiconductor lasers 325-328 serving as excitation light sources; four semiconductor laser bases 335-338 for supporting the semiconductor lasers 325-328 and the solid-state laser medium 312; and a base 342 for supporting the four semiconductor laser bases. Naturally, semiconductor lasers and solid-state laser media in two excitation modules are arranged to be symmetrical with respect to the virtual symmetry plane 61 located at the center gap between the modules.

While this configuration is similar to that in Embodiment 1, shapes of four semiconductor laser bases in each of the excitation modules differ from those in Embodiment 1. Thus, the excitation light of the semiconductor lasers is projected to the solid-state laser media from the entire circumference direction. Specifically, as shown in FIG. 15, four semiconductor lasers are arranged so that the excitation light will be projected from 12, 3, 6, and 9 o'clock directions when viewed from the optical direction of the solid-state laser media.

As a result, from among effects achieved by the solid-state laser device according to Embodiment 1, the effects that the solid-state laser device can be configured simply and its assembling can be simplified are lost. However, because the effect that the solid-state laser media are more uniformly excited is enhanced, it is possible to generate a higher-quality and high-power laser beam with high efficiency.

1.-11. (canceled)

12. A solid-state laser device comprising:
a partial reflection mirror and a total reflection mirror that configure a resonator;
rod-type solid-state laser media of an even number arranged in series on the optical axis of a laser beam between the partial reflection mirror and the total reflection mirror; and
a plurality of excitation light sources for exciting the solid-state laser media from its lateral side, wherein
the plurality of excitation light sources and the solid-state laser media of the even number are arranged to be symmetrical with respect to a virtual plane that is virtually located at a center gap between the solid-state laser media of the even number and that is perpendicular to the optical axis of the laser beam;
two lenses are arranged at the center gap between the solid-state laser media of the even number, and only the distance between the two lenses is shortened compared to that in a transcription optical system in which the center of one of solid-state laser media that are arranged at symmetrical positions with respect to the virtual plane is image-transcribed, by using the two lenses, onto the center of the other solid-state laser medium without changing the distance between each lens and the solid-state laser medium next thereto; and
in a state in which an operation is made under a thermal lens of the solid-state laser media which exceeds thermal lens intensity operable as a stable resonator when the two lenses are arranged at the center gap between the solid-state laser media of the even number and the transcription optical system is configured in which the center of one of the solid-state laser media that are arranged at the symmetrical positions with respect to the virtual plane is image-transcribed, by using the two lenses, onto the center of the other solid-state laser medium, a setting is made in which an excitation distribution of the one solid-state laser medium is image-transcribed onto the other solid-state laser medium.

13. A solid-state laser device comprising:
a partial reflection mirror and a total reflection mirror that configure a resonator;
rod-type solid-state laser media of an even number arranged in series on the optical axis of a laser beam between the partial reflection mirror and the total reflection mirror; and
a plurality of excitation light sources for exciting the solid-state laser media from its lateral side, wherein
the plurality of excitation light sources and the solid-state laser media of the even number are arranged to be symmetrical with respect to a virtual plane that is virtually located at a center gap between the solid-state laser media of the even number and that is perpendicular to the optical axis of the laser beam; and
a transcription optical system, in which the center of one of solid-state laser media that are arranged at symmetrical positions with respect to the virtual plane is image-transcribed onto the center of the other solid-state laser medium, is arranged at the center gap between the solid-state laser media of the even number.

14. The solid-state laser device of claim 12, wherein the partial reflection mirror and the total reflection mirror have the same curvature, and the virtual plane coincides with an optical center of the resonator, thereby making the resonator to be a symmetrical resonator.

15. The solid-state laser device of claim 12, wherein the plurality of excitation light sources are only provided on one side with respect to a first plane containing the optical axis of the laser beam.

16. The solid-state laser device of claim 12, wherein the plurality of excitation light sources are arranged so that there exist two or more different incident angles of excitation light emitted from the excitation light sources with respect to a first plane containing the optical axis of the laser beam.

17. The solid-state laser device of claim 16, wherein, when n excitation light sources are employed to excite one solid-state laser medium among the solid-state laser media, the excitation light sources are arranged so that the incident angles of the excitation light emitted from the excitation light sources with respect to the first plane have an angular deviation of 180/n degrees with each other.

18. The solid-state laser device of claim 17, wherein the excitation light sources are arranged so that, with respect to a second plane that contains the optical axis of the laser beam and that is perpendicular to the first plane, the incident angles, against the second plane, of the excitation light from the excitation light sources for exciting the one solid-state laser medium are symmetrical when viewed from the optical axis direction of the laser beam.

19. The solid-state laser device of claim 12, wherein only one excitation light source is allocated at each spot of the solid-state laser media in the longitudinal direction thereof.

20. The solid-state laser device of claim 15, wherein,
bases each including an excitation light source supporting unit for holding each of the plurality of excitation light sources and a solid-state laser medium supporting unit for holding the solid-state laser medium; wherein,
the width of the solid-state laser medium supporting unit of the base is set to be narrower than the width of the excitation light source supporting unit;
in the plurality of excitation light sources for exciting the same solid-state laser medium among the solid-state laser media, the bases for supporting the respective excitation light sources are provided so that two neighboring excitation light sources are arranged at opposite sides with respect to a second plane that contains the optical axis of the laser beam and that is perpendicular to the first plane; and
the distance between the neighboring bases among the bases is narrower than the width of the excitation light source supporting unit.

21. The solid-state laser device of claim 12, wherein a 90-degree polarizing rotator is arranged at the center gap between the solid-state laser media of the even number.
